(19) United States
(12) Patent Application Publication
(10) Pub. No.: US 2008/0216491 A1
(43) Pub. Date: Sep. 11, 2008

(54) PRESSURE GAUGES AND METHODS OF USE

(76) Inventors: William J. Quest, Dallas, TX (US); Kerry Whitaker, Plano, TX (US)

Correspondence Address: MEYERTONS, HOOD, KIVLIN, KOWERT & GOETZEL, P.C., P.O. BOX 398, AUSTIN, TX, 78767-0398, US

(21) Appl. No.: 11/683,448

(22) Filed: Mar. 8, 2007

(51) Int. Cl. F25B 45/00; G01L 7/00

(52) U.S. Cl. 62/77; 73/700

(57) ABSTRACT

A pressure gauge apparatus for determining refrigerant pressures in a refrigeration system and methods of use are described herein. The pressure gauge apparatus may include a pressure gauge and a faceplate. The faceplate may be rotated such that ambient temperature and a pressure range are visually indicated on the pressure gauge. The pressure range may correlate to an adequate amount of refrigerant in the refrigeration system at ambient temperature.

### BACKGROUND

1. Field of the Invention

The present invention generally relates to pressure gauges. More particularly, the invention relates to pressure gauges that include a rotatable faceplate for refrigerant systems and methods of use.

2. Description of Related Art

One common technique for assessing the charge of a refrigerant system (e.g., an automotive vehicle air conditioning system) is to check the pressure within the refrigerant system by coupling a pressure gauge hose assembly to a service fitting of the refrigerant system (e.g., a low-pressure side fitting of the refrigerant system). A pressure gauge of the pressure gauge hose assembly may be read. If the pressure gauge reading indicates that the refrigerant charge is below a desired level, a charging hose assembly may be coupled to the refrigerant system. Refrigerant added to the refrigerant system through the charging hose assembly. Typically, the pressure reading must be adjusted to take into account the ambient temperature. The reading may be adjusted using temperature charts and/or other reference material to determine the pressure at the ambient temperature.

A first end of a charging hose assembly typically includes a coupling that releasably couples to the service fitting of the refrigeration system. A second end of the charging hose assembly typically includes a shutoff valve that may be secured to an outlet of a pressurized refrigerant container (e.g., a refrigerant can). The charging hose assembly is coupled to the service fitting of the refrigerant system and the valve is opened to allow refrigerant to flow into the refrigerant system from the pressurized refrigerant container. After allowing some refrigerant to flow into the refrigerant system, the valve is closed and the charging hose assembly may be removed from the service fitting. The pressure gauge hose assembly is again coupled to the service fitting to assess the refrigerant charge of the refrigerant system. When the refrigerant charge is sufficient, the pressure gauge hose assembly may be removed from the refrigerant system.

If the refrigerant charge is below a desired level, the charging hose assembly may be reattached to the service fitting and more refrigerant may be added to the refrigerant system. The refrigerant charge may then be reassessed with the pressure gauge hose assembly. These steps may be repeated, using the separate hose assemblies, until the measured pressure within the refrigerant system indicates that the refrigerant system is adequately charged with refrigerant.

U.S. Pat. No. 6,609,385 to Ferris et al.; and U.S. Patent Application Publication No. 2004/0079092 to Ferris et al., both of which are incorporated by reference as if fully set forth herein, describe refrigerant charging/pressure testing hose assemblies that are useable to both check the pressure in a refrigerant system and, if necessary, add refrigerant to the refrigerant system. The assembly includes a refrigerant hose with a quick disconnect coupler that is connectable to the service fitting of the refrigerant system, a piercing-type shutoff valve at the other end that is connectable to a refrigerant container, a pressure gauge coupled into an intermediate portion of the hose, and a check valve in the hose between the shutoff valve and the pressure gauge.

Some manifold assemblies may also be used to pressure test and/or charge a refrigerant system. For example, QUEST™ brand part# 413 (available from E. F. Products, Inc., Dallas, Tex.) is a R-134a Manifold Gauge for use by professional service personnel. Part# 413 includes two pressure gauges. U.S. Pat. Nos. 7,107,781 and 7,124,598 to Quest et al. both of which are incorporated by reference as if fully set forth herein, describe pressure testing and refrigerant recharging conduit assemblies that includes two pressure gauges. The assembly is useable to both check the pressure in a refrigerant system, and if necessary, add refrigerant to the refrigerant system. One pressure gauge may be coupled to the low-pressure side of a refrigerant system using a hose. The other pressure gauge may be coupled to the high-pressure side of the refrigerant system using a hose. Both of the gauges are coupled to valves that open and close flow to the pressure gauges from the hoses. In the manifold, both pressure gauges and both hoses (i.e., the low-pressure side of the refrigerant system and the high-pressure side of the refrigerant system) are in fluid communication with a third hose that may be coupled to a refrigerant container (either a 30 lb. cylinder of refrigerant or, with an adapter, a refrigerant can). Thus, the refrigerant system may be charged through the low-pressure side or the high-pressure side of the refrigerant system. Charging of a refrigerant system through the high-pressure side of the refrigerant system may be dangerous and should only be performed by professional service personnel.

### SUMMARY

In some embodiments, a pressure gauge apparatus for determining refrigerant pressures in a refrigeration system may include a pressure gauge and a rotatable faceplate. Rotation of the faceplate may visually define a pressure range at a selected temperature. The defined pressure range may correlate to an adequate amount of refrigerant in the refrigeration system at the selected temperature.

In some embodiments, the faceplate may include a temperature indicator, a low pressure indicator, an upper pressure indicator and a grip. The indicators may be coupled to the faceplate. Rotation of the grip may allow the temperature indicator to be pointed at a desired temperature while positioning the low pressure indicator and the upper pressure indicator at pressures on the pressure gauge. The pressure values encompassed by the low pressure indicator and upper pressure indicator may define an adequate amount of refrigerant in a refrigeration system. In some embodiments, the faceplate is removably coupled to a pressure gauge suitable for measuring refrigeration system pressures.

In some embodiments, a combination pressure measurement/refrigerant charging apparatus may include a shutoff valve. The shutoff valve may include a piercing pin and a pressure gauge. In some embodiments, the pressure gauge may include a temperature/pressure range indicator assembly. The piercing pin may be used to pierce a refrigerant can during use. The pressure gauge may be used as a handle for operating the shutoff valve during use. A first end of a hose may be coupled to the shutoff valve. A quick coupling device may be coupled to a second end of the hose. The quick coupling device may be used to couple the apparatus to a refrigerant system. In some embodiments, the quick coupling device may only couple to a low-pressure side of the refrigerant system.

A pressure of the refrigerant system may be measured when the shutoff valve is closed. Fluid, either a liquid or a gas, may be allowed to flow from the refrigerant can to the refrigerant system when the shutoff valve is open. The piercing pin may be moved back and forth relative to a sealing seat by operating (e.g., rotating) the pressure gauge. This movement of the piercing pin may open and close the shutoff valve.

In some embodiments, a combination pressure measurement/refrigerant charging system may include a conduit. The conduit may be coupled to a refrigerant can and to a low-pressure side of a refrigerant system. The pressure measurement/refrigerant recharging system may include a valve. The valve may control a flow of fluid through the conduit. Thus, the valve may control the flow of fluid between the refrigerant can and the low-pressure side of the refrigerant system.

In certain embodiments, a first pressure gauge that includes a temperature/pressure range indicator assembly may be in fluid communication with the conduit. The first pressure gauge may be coupled to the low-pressure side of the refrigerant system. The first pressure gauge may operate the valve to control fluid flow through the conduit. A second pressure gauge may be coupled to a high-pressure side of the refrigerant system. The second pressure gauge may be isolated from fluids that flow through the conduit.

In certain embodiments, the conduit and the valve may be located inside a body (e.g., a manifold). The first pressure gauge and the second pressure gauge may be coupled to the body. A hose may couple the conduit to a refrigerant can. A can piercing valve may be coupled to an end of the hose that is coupled to a refrigerant can. A second hose may couple the first pressure gauge to the low-pressure side of the refrigerant system. A third hose may couple the second pressure gauge to the high-pressure side of the refrigerant system. The second and third hoses may include shutoff valves and/or quick coupling devices. The quick coupling devices may be used for coupling to the refrigerant system.

In an embodiment, the first pressure gauge may be used as a handle to operate (e.g., open and close) the valve. Closing the valve may allow a pressure of the low-pressure side of the refrigerant system to be measured. Opening the valve may allow fluid to flow from the refrigerant can to the refrigerant system.

The valve may include a pin and a sealing seat. The valve may be closed when a portion of the pin presses against the sealing seat. Operation (e.g., rotation) of the first pressure gauge may move the pin back and forth relative to the sealing seat. Thus, operation of the first pressure gauge may open and close the valve by moving the pin relative to the sealing seat.

### BRIEF DESCRIPTION OF THE DRAWINGS

Advantages of the present invention may become apparent to those skilled in the art with the benefit of the following detailed description and upon reference to the accompanying drawings in which:

FIG. 1 depicts a front view of an embodiment of a pressure gauge apparatus.

FIG. 2 depicts a front view of an embodiment of a temperature/pressure range indicator assembly.

FIGS. 3A through 3C depict front views of embodiments of a pressure gauge apparatus during use.

FIG. 4 depicts a side view of an embodiment of a pressure gauge and valve assembly with the valve assembly shown in cross-section FIG. 5 depicts a side view of an embodiment of a pressure gauge, valve, and hose apparatus.

FIG. 6 depicts a flowchart of an embodiment of a method for pressure testing and/or recharging a refrigerant system.

FIG. 7 depicts an embodiment of a pressure measurement and charging assembly.

FIG. 8 depicts an embodiment of a pressure measurement and charging assembly with hoses.

FIG. 9 depicts a schematic representation of a pressure measurement and charging assembly as depicted from a front-end view of the assembly.

FIG. 10A depicts a front view a low-pressure side of a pressure measurement and charging assembly without the pressure gauge.

FIG. 10B depicts a cross-sectional representation of a low-pressure side of a pressure measurement and charging assembly taken substantially along line B-B of FIG. 10A.

FIG. 10C depicts a bottom view of a low-pressure side of a pressure measurement and charging assembly without the pressure gauge.

FIG. 10D depict cross-sectional representation of a low-pressure side of a pressure measurement and charging assembly taken substantially along line C-C of FIG. 10A.

FIG. 11A depicts a front view of a high-pressure side of a pressure measurement and charging assembly without the pressure gauge.

FIG. 11B depicts cross-sectional representations of a high-pressure side of a pressure measurement and charging assembly taken substantially along line B-B of FIG. 11A.

FIG. 11C depicts a bottom view of a high-pressure side of a pressure measurement and charging assembly without the pressure gauge.

FIG. 12A depicts a front view of an embodiment of an outer body of a pressure measurement and charging assembly without the pressure gauge.

FIG. 12B depicts a cross-sectional representation taken substantially along line B-B of FIG. 12A.

FIG. 12C depicts a cross-sectional representation taken substantially along line C-C of FIG. 12A.

FIG. 13A depicts a bottom view of an embodiment of an outer body of a pressure measurement and charging assembly without the pressure gauge.

FIG. 13B depicts a cross-sectional representation taken substantially along line B-B of FIG. 13A.

FIG. 13C depicts a cross-sectional representation taken substantially along line C-C of FIG. 13A.

FIG. 14A depicts a top view of an embodiment of a plunger.

FIG. 14B depicts a front view of embodiment of the plunger depicted in FIG. 14A

FIG. 14C depicts a cross-sectional representation taken substantially along line C-C of FIG. 14A.

FIGS. 15A and 15B depict top and front views, respectively of an embodiment of a pin.

FIG. 16A depicts representations of an embodiment of a plunger in an opening in an open fluid flow position.

FIG. 16B depicts an embodiment of a plunger in an opening in a closed fluid flow position.

FIG. 17 depicts a flowchart of an embodiment of a method for pressure testing and/or recharging a refrigerant system.

While the invention is susceptible to various modifications and alternative forms, specific embodiments thereof are shown by way of example in the drawings and may herein be described in detail. The drawings may not be to scale. It should be understood, however, that the drawings and detailed description thereto are not intended to limit the invention to the particular form disclosed, but on the contrary, the intention is to cover all modifications, equivalents, and alternatives falling within the spirit and scope of the present invention as defined by the appended claims.

### DETAILED DESCRIPTION

A pressure gauge apparatus that includes a faceplate is described herein. The pressure gauge apparatus may be used to monitor a refrigeration system and/or to recharge a refrigeration system with refrigerant. The pressure gauge apparatus may include a pressure scale, a pressure indicator, a temperature scale, and a rotatable face plate. The rotatable face plate may include a temperature indicator, pressure range indicators and/or indicia. Rotation of the face plate may allow a user to point the temperature indicator at a desired temperature (e.g., ambient temperature) on the temperature scale. Positioning the temperature indicator positions the low pressure range indicator and the upper pressure range indicator to identify a desired pressure range. In some embodiments, the difference between the upper pressure indicator and the low pressure indicator may be about 1 psi, about 10 psi, about 15 psi, or about 20 psi.

The pressure gauge apparatus indicates that there is sufficient refrigerant in the refrigeration system when the temperature indicator is positioned on the temperature scale at ambient temperature, and the pressure indicator is between the low pressure range indicator and the high pressure range indicator when the refrigerant system is operating at maximum cooling. For refrigeration systems being used at temperatures ranging from about 50° F. to about 65° F., the in-range charging pressure ranges from about 15 to about 35 psi. The in-range charging pressure may range from about 25 psi to about 40 psi for refrigeration systems being used at temperatures ranging from about 65° F. to about 70° F. For refrigeration systems being used at temperatures ranging from about 70° F. to about 75° F., the in-range charging pressure may range from about 30 psi to about 45 psi. The in-range charging pressure may range from about 35 psi to about 50 psi for refrigeration systems being used at temperatures ranging from about 75° F. to about 80° F. For refrigeration systems being used at temperatures ranging from about 80° F. to about 85° F. up to about 110° F., the in-range charging pressure may range from about 40 psi to about 55 psi. For refrigeration systems being used at temperatures greater than 110° F., the in-range charging pressure may range from about 45 psi to about 55 psi.

During use (e.g., during charging of a refrigeration system or during monitoring of refrigerant level of a refrigeration system), pressures below the low pressure indicator may indicate that the refrigeration system has an insufficient amount (e.g., a low charge) of refrigerant in the system. In the case of low charge, refrigerant may be added to the refrigeration system. In some embodiments, refrigeration is charged to the refrigeration system until the pressure indicator moves into the desired pressure range. Pressures in the desired range (e.g., pressures between the low pressure range indicator and the upper pressure range indicator) may indicate that a sufficient amount of refrigerant is in the system. Thus, charging of the system with refrigerant may be discontinued or is not necessary. Pressure above the upper pressure indicator may indicate that the system has been charged with too much refrigerant (e.g., over-charged). Refrigerant may be removed from the system until the pressure indicator moves into the desired pressure range.

Being able to monitor the pressure at the ambient temperature during charging of a refrigeration system allows refrigerant to be charged more accurately. Having the desired pressure range at a ambient temperature on the face of the pressure gauge may eliminate the use of temperature charts and/or other reference material necessary to determine the correct pressure at ambient temperature. Elimination of charts and/or reference materials may allow the level of refrigerant in a system to be monitored and/or adjusted in a more efficient manner.

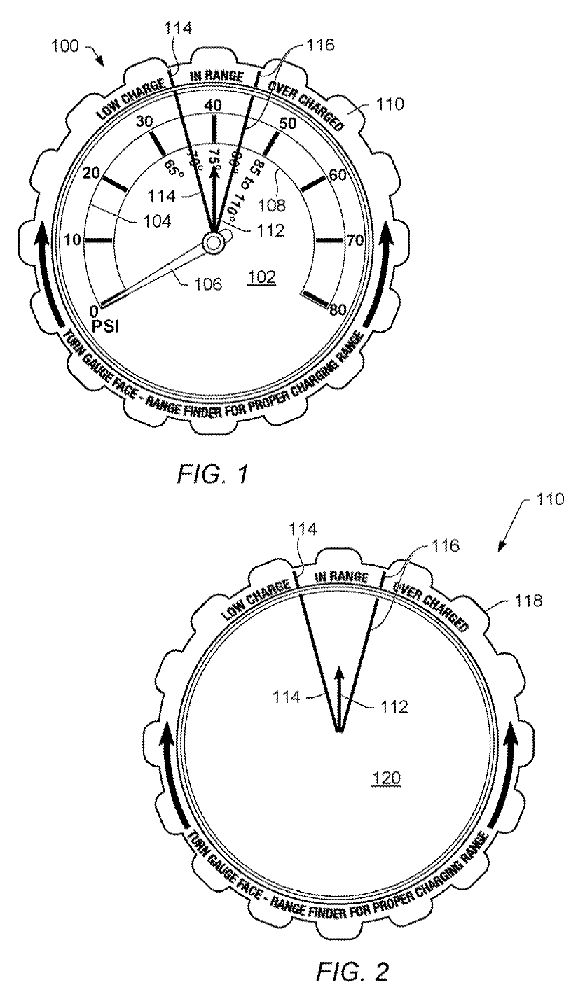

FIG. 1 depicts a front view of an embodiment of pressure gauge apparatus 100. In some embodiments, pressure gauge apparatus 100 is a temperature compensated pressure gauge. Pressure gauge apparatus 100 includes pressure gauge 102, pressure scale 104, pressure indicator 106, temperature scale 108, and rotatable faceplate 110.

Pressure scale 104 includes pressure indicia in units of pressure (e.g., pounds per square inch (psi)). For example, pressure scale 104 may include indicia ranging incrementally from 0 psi to 80 psi, from 0 psi to 100 psi, or from 0 psi to 200 psi. It should be understood that any pressure scale and/or pressure units suitable for charging refrigeration systems can be used. In some embodiments, pressure gauge apparatus 100 may include one or more pressure scales. The pressure indicia may be angularly oriented with respect to the axis about which pressure indicator 106 rotates, and is properly coordinated with pressure indicator 106 so that during use an accurate pressure reading may be obtained. Pressure scale 104 may be colored to enhance readability of measured pressures.

Pressure indicator 106 may be coupled to pressure gauge using any known technique in the art to couple pressure indicators to pressure gauges (e.g., pinned, welded, epoxied). During use, pressure indicator 106 rotates to indicate the pressure of the system on pressure scale 104. For example, pressure indicator may rotate clockwise from about 0 psi to about 50 psi during charging of a refrigerant to a refrigeration system. Pressure indicator 106 may be a different color than pressure scale 104 to enhance readability of the pressure during use.

Temperature scale 108 may be located on a face of pressure gauge 102 and includes indicia. The indicia correlate to increments of temperature. The temperature indicia may be angularly oriented with respect to the axis about which pressure indicator 106 rotates. In some embodiments, temperature scale 108 is a separate insert that is coupled to pressure gauge 102.

FIG. 2 depicts an embodiment of rotatable faceplate 110. Rotatable face plate 110 may include temperature indicator 112 and pressure range indicators 114, 116. Temperature indicator 112, low pressure indicator 114, and/or upper pressure indicator 116 may be printed, etched, painted thereon, or otherwise placed on faceplate 110. In some embodiments, temperature indicator 112, low pressure indicator 114, and/or upper pressure indicator 116 are coupled or directly attached to the body of pressure gauge apparatus 100. As shown in FIG. 2, low pressure range indicator 114, and upper pressure range indicator 116 may be coupled together to form a V-shape with temperature indicator 112 positioned approximately halfway between the low pressure range indicator and the upper pressure range indicator to form temperature/pressure range indicator assembly. When faceplate 116 is rotated relative to the body of pressure gauge assembly 100, temperature indicator 112, low pressure indicator 114, and upper pressure indicator 116 may rotate about the rotation axis of pressure indicator 106.

Temperature indicator 112, low pressure range indicator 114, and/or upper pressure range indicator 116 may be a different color than pressure scale 104 and/or pressure indicator 106. Making the temperature indicator and/or the pressure range indicators different colors may enhance readability and/or contrast the pressure indictors and desired pressure range during use.

Rotation of faceplate 110 may allow temperature indicator 112 to be pointed at a temperature indicia on temperature scale 108. In some embodiments, temperature indicator 112 is pointed at or positioned proximate temperature indicia corresponding to ambient temperature. Positioning temperature indicator 112 positions low pressure range indicator 114 and upper pressure range indicator 116 at pressure indicia on pressure scale 104. The pressure between low pressure range indicator 114 and upper pressure range indicator 116 may define a desired pressure range for indicating a sufficient refrigerant charge to a refrigeration system at the selected temperature.

Rotatable faceplate 110 may be coupled to, directly attached to, or be a part of at least a portion of the body of pressure gauge 102. Rotatable faceplate 110 may include ridges and/or other features that allow a user to grip and rotate the faceplate. In some embodiments, a portion or portions of pressure gauge 102 and/or rotatable outer surface 110 may include text and/or graphics (e.g., arrows) to instruct an operator how to operate the faceplate. For example, text on dial 110 may read “Turn gauge face-range finder for proper charging range.”

Faceplate 110 may include text that indicates if the amount of refrigerant that has been charged to the refrigeration unit is sufficient. Text below low pressure range indicator 114 on rotatable outer surface 110 may read “low charge”. Text between lines low pressure range indicator 114 and upper pressure range indicator 116 may read “in range”. Text outside of upper pressure range indicator 116 on rotatable outer surface 110 may read “over charged.” Other text such as “danger”, “high”, and/or “alert” may also be printed on a face of pressure gauge 102 and/or on faceplate 110.

A face of pressure gauge 102 may include instructions for use of the temperature indicator. For example, text printed on pressure gauge 102 may read “Point Green Arrow to temperature around vehicle. Charge to indicated range.”

In some embodiments, temperature/pressure range indicator assembly 120 is removably attached to pressure gauge apparatus 100. As shown in FIG. 2, Faceplate 110 includes temperature indicator 112, low pressure range indicator 114, upper pressure range indicator 116, grip 118 and cover 120. Cover 120 may be manufactured from glass, plastic, or any suitable material that allows materials and/or text to be viewed through the cover. Temperature indicator 112, low pressure indicator 114, upper pressure indicator 116, and temperature scale 108 may be printed on an outer surface of cover 120 using any technique known in the art (e.g., printed, painted, decaled, etched, etc.) to print text and graphics on see through materials. Cover 120 may be coupled to or directly attached to grip 118. For example, grip 118 may be manufactured from rubber and include an inner groove that cover 120 may be positioned in. Temperature/pressure range indicator assembly 120 may be positioned over an outer surface of a pressure gauge.

A portion of faceplate 110 may include a protrusion or ring that resides in a groove formed in the body of the pressure gauge and allows the faceplate to be rotated relative to the pressure gauge. In some embodiments, the body of the pressure gauge may include at least one protrusion or rim that fits in a groove in the faceplate and allows the faceplate to be rotated relative to the pressure gauge. In some embodiments, the connection between the faceplate and the pressure gauge may include a ratchet system or other system that inhibits undesired movement of the face plate relative to the body of the pressure gauge.

In some embodiments, temperature/pressure range indicator assembly 120 is positioned over a pressure gauge that includes a temperature scale. U.S. Pat. Nos. 6,318,173 and 6,094,983 to Pearl, both of which are incorporated herein by reference, describe pressure gauges with corresponding temperature scales for various refrigerants. Pressure gauges that include corresponding temperature scales are commercially available from Weiss Instruments, Inc. (Holtsville, N.Y.). Faceplate 110 may be rotated to point temperature indicator 112 at the desired temperature. Selection of the desired temperature defines a pressure range for an adequate charge of refrigerant in a refrigeration system as described herein.

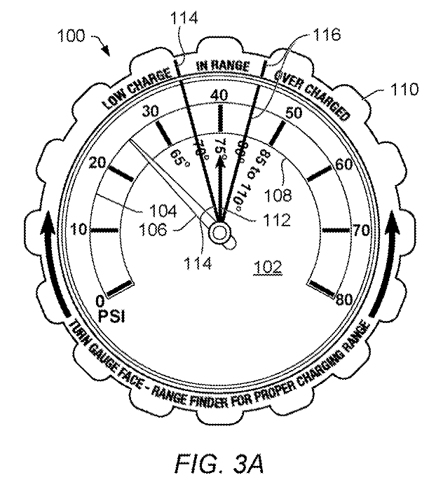

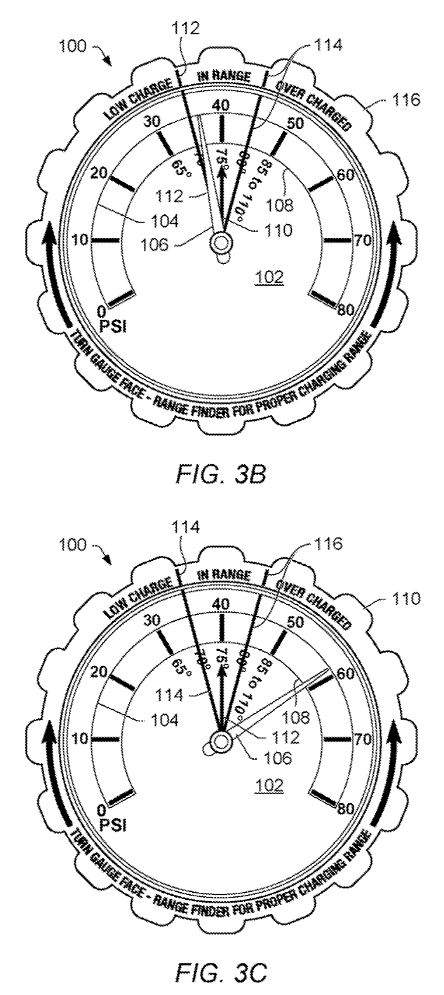

A pressure gauge apparatus as described herein that allows a user to select a temperature which correlates to a desired pressure range may allow assessment of the refrigeration system without having to access multiple charts, reference materials, and/or digital readouts. For example, pressure gauge apparatus 100 may be coupled to a low side of a refrigeration system. If the ambient temperature is 75° F., faceplate 110 is rotated to point temperature indicator 112 at 75° F. on temperature scale 108. Pointing temperature indicator 112 at 75° F. sets low pressure range indicator 114 at 35 psi and upper pressure range indicator 116 at 45 psi. A valve on the refrigeration unit may be opened to a refrigeration system and the pressure of the system may be measured. The pressure of the refrigeration system is determined to be the pressure at which pressure indicator 106 points to on pressure scale 104. As shown in FIG. 3A, pressure indicator 106 stopped below low pressure range indicator 114 so the system requires additional refrigerant. As shown in FIG. 3B, pressure indicator 106 stopped between low pressure range indicator 114 and upper pressure range indicator 116, so no refrigerant needs to be added to the system. As shown in FIG. 3C, pressure indicator 106 stopped above upper pressure range indicator 116 so the system contains excess refrigerant.

During charging of refrigerant to the refrigeration system (e.g., an automobile refrigeration system, a residential refrigeration system, or a commercial refrigeration system) pressure gauge apparatus 100 may be coupled to the low side of the refrigeration system. During charging, the pressure of the refrigeration system is monitored using pressure gauge apparatus 100. Refrigerant is added until pressure indicator 106 enters the pressure range between low pressure range indicator 114 and upper pressure range indicator 116 (see for example, FIG. 3B). Once pressure indicator 106 is in the desired pressure range, charging of refrigerant is stopped.

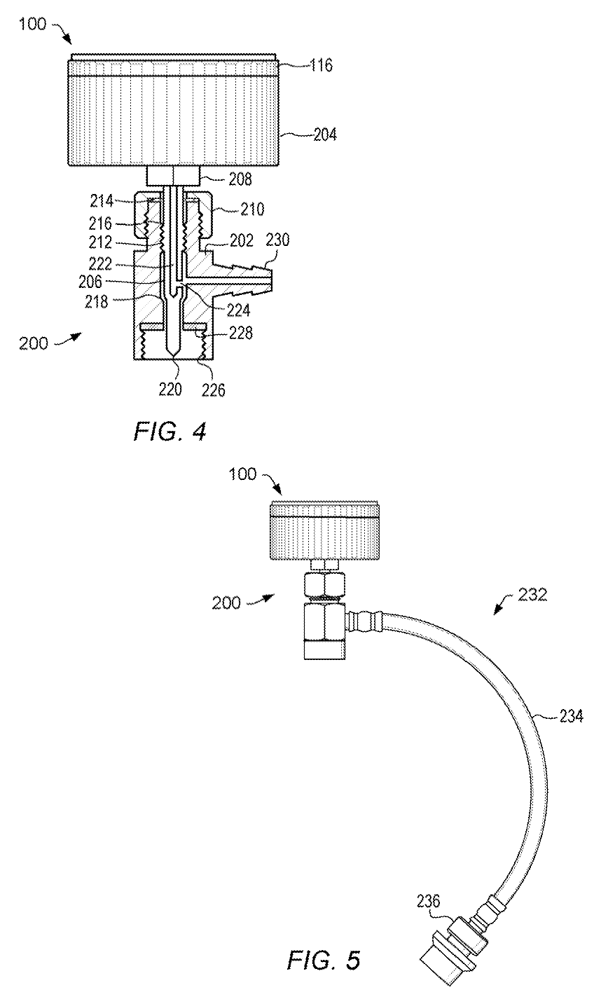

Pressure gauge apparatus 100 may be used a part of pressure assemblies and/or pressure manifolds. FIG. 4 depicts a side view of an embodiment of a pressure gauge apparatus with the valve shown in cross-section. Valve assembly 200 may include body 202. In some embodiments, other types of pressure gauge or other pressure measurement devices are maybe used. Pressure gauge apparatus 100 may be used as a handle to operate valve assembly 200. In certain embodiments, pressure gauge apparatus 100 may include ridges and/or other features that allow a user to grip and rotate body 204 of the pressure gauge relative to valve assembly 200 to activate the valve assembly. Allowing pressure gauge apparatus 100 to activate valve assembly 200 may simplify the design of valve assembly 200 and/or reduce costs for manufacturing the valve assembly.

Pressure gauge body 204 may be coupled to pin 206. Pin 206 may be coupled to pressure gauge body 204 such that a tight seal is formed between the pin and the gauge. For example, pin 206 may be coupled to pressure gauge body 204 using nut 208. In an embodiment, nut 208 may be a knurled press fitting. Nut 208 may be coupled (e.g., threaded, glued, epoxied, and/or welded) to pin 206 and thread onto a threaded portion of gauge body 204 to form a seal (e.g., a tight seal) between pin 206 and pressure gauge apparatus 100. In some embodiments, the use of nut 208 to couple pin 206 to pressure gauge body 204 may be reversed. For example, nut 208 may be coupled to pressure gauge body 204 and thread onto a threaded portion of pin 206. In some embodiments, an o-ring or gasket inside nut 208 may provide a seal between pin 206, nut 208, and pressure gauge body 204.

In some embodiments, pin 206 may be permanently coupled to pressure gauge body 204. For example, pin 206 may be bonded (e.g., glued, epoxied, or welded) to pressure gauge body 204. In some embodiments, pin 206 may be formed as a portion of pressure gauge apparatus 100. Pin 206 may be made of materials chemically inert to refrigerant (e.g., stainless steel or aluminum). Pin 206 may be coupled to pressure gauge body 204 such that the pin rotates when pressure gauge body 204 is turned.

Pin 206 and pressure gauge apparatus 100 may be coupled to body 202 with nut 210. Nut 210 may be a retainer nut. An inside diameter of a portion of nut 210 may be slightly larger than the outside diameter of pin 206 so that the nut moves freely up and down the body of the pin. A portion of nut 210 may have an inside diameter that is less than a diameter of pin 206 at threads 212 so that the nut does not pass over the threads. Gasket 214 may be located inside nut 210 to provide a seal between pin 206, nut 210, and body 202. In some embodiments, gasket 214 may include one or more pieces that together provide a seal between pin 206, nut 210, and body 202. Gasket 214 may be made of one or more materials that are chemically inert to fluid in assembly 200.

Pin 206 may include threads 212. Threads 212 may engage threads 216 of body 202 such that rotation of pressure gauge apparatus 100 rotates pin 206. Rotation of pin 206 may cause the pin to move along threads 212 and translate relative to body 202. As pin 206 translates relative to body 202, the pin may form a seal when pressed against seat 218. A portion of pin 206 that presses against seat 218 may be complementary to the shape of seat 218 so that a tight seal is formed between the pin and the seat. Sealing pin 206 against seat 218 may inhibit flow of fluids between a refrigerant can and a hose coupled to assembly 200. Thus, assembly 200 may operate as a shutoff valve between a refrigerant can and a hose coupled to the assembly.

In certain embodiments, pin 206 may include tip 220. Tip 220 may be a piercing tip (e.g., a can piercing tip). Tip 220 may be used to pierce a refrigerant can or other refrigerant container coupled to assembly 200. Tip 220 may be formed of hardened material (e.g., stainless steel). In an embodiment, pin 206, including tip 220, is made of one material as a single formed body. In some embodiments, pin 206 may be made of two or more pieces.

Pin 206 may include hollow portion 222. Hollow portion 222 may be in fluid communication with pressure gauge apparatus 100, as shown in FIG. 4. Hollow portion 222 may also be in fluid communication with the interior of body 202 through access port 224. Thus, pressure gauge apparatus 100 may be used to measure a pressure of fluid (e.g., refrigerant) in body 202.

Body 202 may be made of one or more materials chemically inert to fluid (e.g., refrigerant) used in a refrigerant system. In certain embodiments, body 202 may include two or more pieces of differing materials that are coupled (e.g., bonded). For example, body 202 may have a plastic outer portion coupled to or bonded over a metal (e.g., brass) interior portion.

Body 202 may include can thread 226. Can thread 226 may be used to couple assembly 200 to a refrigerant container (e.g., a refrigerant can). The refrigerant container may have a threaded portion that mates with can thread 226. Gasket 228 may be used to provide a seal between body 202 and the refrigerant container. Gasket 228 may be made of one or more materials that are chemically inert to fluid from the refrigerant container. In certain embodiments, the refrigerant can may be coupled to assembly 200 with pin 206 and tip 220 in a retracted position such that the refrigerant can is not pierced when the can is coupled to the assembly.

In certain embodiments, can thread 226 may be selected to mate exclusively with a threaded portion of certain refrigerant containers. For example, can thread 226 may only mate with a threaded portion of an R-134a refrigerant container.

Body 202 may include hose coupler 230. Hose coupler 230 may be, for example, a hose barb or other device for coupling a refrigerant hose to assembly 200. In certain embodiments, the hose may be permanently attached to hose coupler 230. For example, the hose may be crimped to hose coupler 230 (e.g., the hose may be crimped over the hose coupler using a metal crimp sleeve). The hose may be coupled to hose coupler 230, however, using any method known in the art.

FIG. 5 depicts an embodiment of a pressure gauge, valve, and hose apparatus. Apparatus 232 may include assembly 200, hose 234, and coupling device 236. Apparatus 232 may be used for pressure testing and/or charging of a refrigerant system (e.g., a motor vehicle refrigerant system). In certain embodiments, apparatus 232 may be used with a refrigerant system that uses R-134a as the refrigerant fluid. Hose 234 may be coupled (e.g., connected with one or more intervening members) to assembly 200 and coupling device 236. Hose 234 may be a flexible hose. Hose 234 may be made of materials that are chemically inert to refrigerant fluid including, but not limited to, rubber, polyvinylchloride, polyethylene, polypropylene, polytetrafluoroethylene, and mixtures thereof. Hose 234 may be 12″ or less in length. Longer lengths of hoses may require a shutoff valve at some point along the length of the hose to satisfy Environmental Protection Agency (EPA) regulations.

In an embodiment, coupling device 236 may be a quick coupling device (e.g., a 14 mm×13 mm quick coupler device). Coupling device 236 may couple to an inlet port of the refrigerant system (e.g., a motor vehicle refrigerant system). Coupling device 236 may be coupled to an inlet port of a refrigerant system by pulling back an outer connector ring as the coupling device is pushed onto the inlet port. In certain embodiments, coupling device 236 may be designed to be coupled to only one side of a refrigerant system (e.g., a low-pressure side). Designing coupling device 236 to only couple to the low-pressure side of a refrigerant system may inhibit a user from accidentally coupling apparatus 232 to the high-pressure side of the refrigerant system, thus avoiding potential safety hazards.

In certain embodiments, apparatus 232 may be used as a gauge for measuring pressure of the refrigerant system and as a controller for allowing or stopping the introduction of refrigerant into the refrigerant system. FIG. 6 depicts a flowchart of an embodiment of a method for pressure testing and/or recharging the refrigerant system using apparatus 232. Steps in the method depicted in FIG. 6 may reference elements identified in the embodiments depicted in FIGS. 1-5. In certain embodiments, the pressure of a low-pressure side of refrigerant system may be measured with or without a refrigerant can coupled to apparatus 232 by using Option 1 or Option 2, respectively, depicted in FIG. 6.

In Option 1, pressure gauge apparatus 100 is rotated (e.g., counterclockwise) until tip 220 is in a retracted position (step 240). With tip 220 in a retracted position, accidental piercing of a refrigerant can may be avoided during coupling of apparatus 232 to the refrigerant can. A refrigerant can may then be coupled to apparatus 232 using can thread 226 (step 242). A user may start the refrigerant system (e.g., by starting the engine of a motor vehicle) and operate the refrigerant system at maximum cooling (step 244). Coupling device 236 may be coupled to the low-pressure side service port of the refrigerant system (step 246). After coupling to the refrigerant system, pressure gauge apparatus 100 may be used to measure a low-pressure side pressure of the refrigerant system (step 248) and to indicate the level of refrigerant in the refrigeration system. Faceplate 110 may be rotated to position temperature indicator 112 at ambient temperature outside of the refrigeration system (e.g., outside air temperature), thus positioning low pressure range indicator 114 and upper pressure range indicator 116 to indicate a desired pressure range for the selected ambient temperature. The measured pressure, as shown by movement of pressure indicator 104, may fall outside or in the desired pressures defined by pressure indicators 114, 116.

In Option 2, pressure gauge apparatus 100 is rotated (e.g., counterclockwise) until tip 220 is extended (e.g., fully extended) (step 250). Extension of tip 220 inhibits refrigerant from escaping apparatus 232 during pressure measurement even when a refrigerant system is not coupled to can thread 226. A user may start the refrigerant system (e.g., by starting the engine of a motor vehicle) and operate the refrigerant system at maximum cooling (step 252). Coupling device 236 may be coupled to a low-pressure side service port of the refrigerant system (step 254). After coupling to the refrigerant system, pressure gauge apparatus 100 may be used to measure a low-pressure side pressure of the refrigerant system (step 256) to indicate an amount of refrigerant in the refrigeration system. Faceplate 110 may be rotated to position temperature indicator 112 at ambient temperature outside of the refrigeration system (e.g., outside air temperature), thus positioning low pressure range indicator 114 and upper pressure range indicator 116 to indicate a desired pressure range for the selected ambient temperature. The measured pressure, as shown by movement of pressure indicator 104, may fall outside or in the desired pressures defined by pressure indicators 114, 116. Apparatus 232 may be disconnected from the refrigerant system after measuring the pressure and before a refrigerant can is attached to the apparatus (step 258).

If the pressure measured in step 248 or in step 256 indicates that refrigerant level in the refrigerant system is below a desired level, apparatus 224 may be used to supply refrigerant to the refrigerant system. If Option 2 was used to measure the pressure, steps 240, 242, 244, and 246 may be used to couple apparatus 232 to a refrigerant can. Step 248 may be skipped and the user may begin charging of the refrigerant system at step 260. If Option 1 was used to measure the pressure, a user may begin charging of the refrigerant system at step 260.

In step 260, pressure gauge apparatus 100 of assembly 200 may be rotated (e.g., clockwise) until tip 220 punctures the refrigerant can. Faceplate 110 may be rotated such that temperature indicator 112 points to temperature scale 108 to indicate ambient temperature and move temperature indicators 114, 116 to define the desired pressure ranges on pressure scale 104 for sufficient refrigerant at ambient temperature.

Pressure gauge body 204 may then be rotated in an opposite direction (e.g., counterclockwise) to allow refrigerant to enter apparatus 232 (step 262). A user may hear refrigerant leaving the refrigerant can. During charging, the user may monitor the pressure of the system by watching pressure indicator 106 move toward lower pressure range indicator 114 positioned at the lower pressure range of the desired pressure. After allowing at least some refrigerant to enter the refrigerant system, the user may rotate pressure gauge apparatus 100 to close off the flow of refrigerant. A pressure of the refrigerant system may be assessed (step 264). Shutting off of the system may allow the system to equilibrate so that a more accurate pressure reading may be taken. If the refrigerant system pressure is still too low, steps 260, 262, and 264 may be repeated until a sufficient refrigerant system pressure is achieved. After sufficiently filling the refrigerant system with refrigerant, apparatus 232 may be uncoupled from the refrigerant system (step 266).

An empty refrigerant can may be uncoupled from apparatus 232 and disposed of properly (e.g., recycled). Apparatus 232 may be stored with tip 220 retracted, thus inhibiting accidental piercing of the next refrigerant can coupled to the apparatus. If the refrigerant can is not empty, the refrigerant can may remain coupled to apparatus 232 for later use. Care should be taken in storing apparatus 232 and the refrigerant can to inhibit accidental opening and/or puncturing of the refrigerant can.

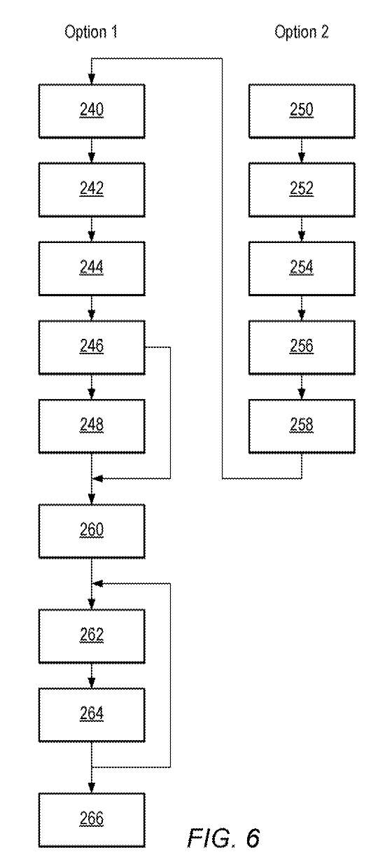

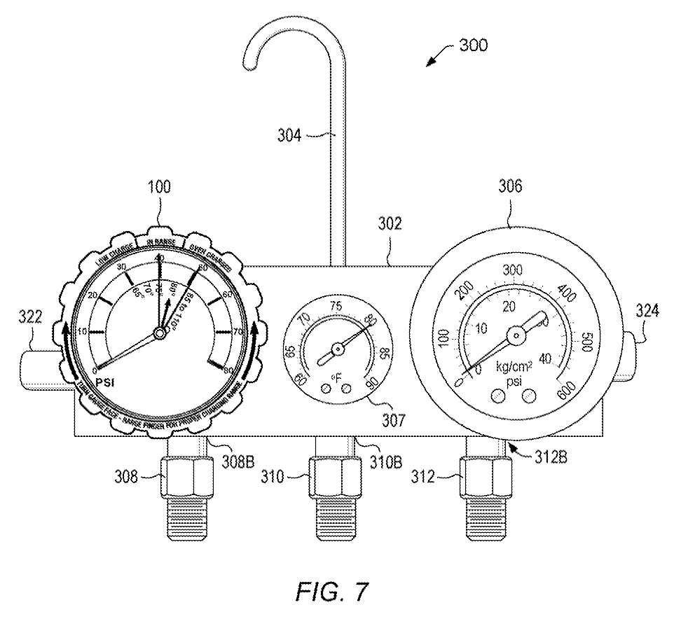

FIG. 7 depicts an embodiment of pressure measurement and charging assembly 300. Assembly 300 may be used for assessing pressure and/or charging of a refrigerant system (e.g., a motor vehicle refrigerant system). In certain embodiments, assembly 300 may be used with a refrigerant system that uses R-134a as the refrigerant fluid. Assembly 300 may include outer body 302. Outer body 302 may be made of, for example, metal (e.g., aluminum and/or steel) and/or one or more other materials (e.g., plastic) that are chemically inert to refrigerant fluid. Hanger 304 may be coupled to outer body 302. Hanger 304 may be used to hang or support assembly 300 during use (e.g., from a hood of a motor vehicle) and/or during storage of the assembly. In some embodiments, hanger 304 may be threaded into outer body 302. Hanger 304 may have a length, for example, of about 6″.

Assembly 300 may include low-pressure side gauge apparatus 100 and high-pressure side gauge 306. Pressure gauge apparatus 100 may be used to measure a low-pressure side pressure of the refrigerant system. Pressure gauge 306 may be used to measure a high-pressure side pressure of the refrigerant system. Pressure gauge 306 may be a dial-type pressure gauge. A dial-type pressure gauge may include one or more selected pressure ranges (e.g., normal pressure range, low pressure range, high or over pressure range, alert pressure range, and/or danger pressure range). Pressure ranges indicated on gauges 100, 306 may be chosen to represent pressure ranges based on a desired use for assembly 300. For example, pressure gauge apparatus 100 may have a lower pressure range (e.g., 0 psi to about 100 psi, 0 psi to 80 psi, or 0 psi to 60 psi) than high-pressure side gauge 306 (e.g., 0 psi to about 600 psi). The gauges may have different ranges if desired. In some embodiments, as shown in FIG. 7, assembly 300 may include thermometer 307. Thermometer may be a digital readout thermometer or a gauge thermometer. In some embodiments, the indicated pressure ranges may be color-indexed to provide additional visual identification of the pressure ranges. In some embodiments, gauge 306 may be a digital readout pressure gauge. In some embodiments, gauges 100, 306 may be located on top of outer body 302 (e.g., on the same side of outer body 302 as hanger 304).

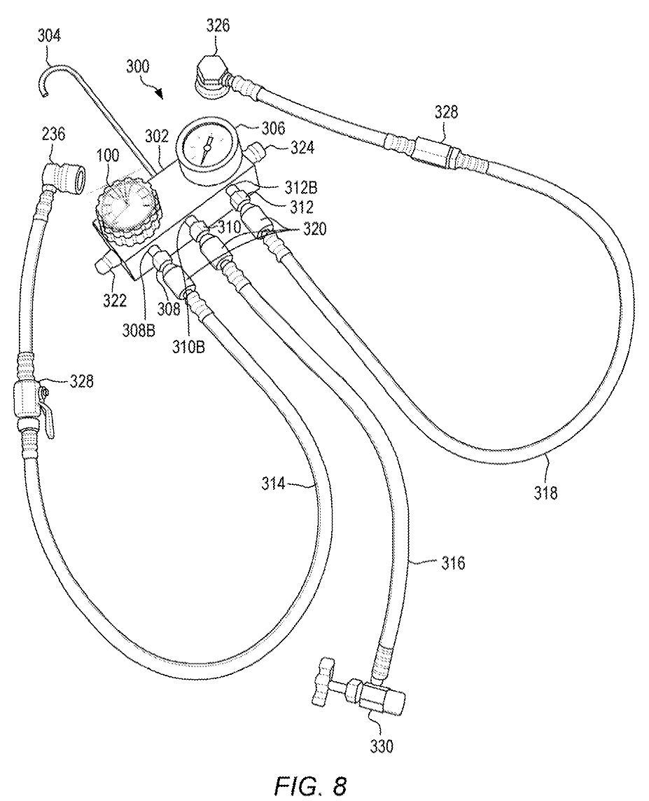

Assembly 300 may include low-pressure side coupler 308, refrigerant can coupler 310, and high-pressure side coupler 312. FIG. 8 depicts an embodiment of a pressure measurement and charging assembly with hoses. Low-pressure side coupler 308 may be coupled to conduit 314 (e.g., a hose) that is coupled to a low-pressure side inlet port of the refrigerant system. Refrigerant can coupler 310 may be coupled to conduit 316 (e.g., a hose) that is coupled to a refrigerant can. High-pressure side coupler 312 may be coupled to conduit 318 (e.g., a hose) that is coupled to a high-pressure side inlet port of a refrigerant system. In certain embodiments, couplers 308, 310, 312 may be coupled to outer body 302. For example, couplers 308, 310, and/or 312 may be double male-NPT (National Pipe Thread) fittings with one end for coupling to outer body 302 (at openings 308B, 310B, and 312B, respectively) and one end for coupling to conduits or hoses. In this case, conduits (e.g., conduits 314, 316, 318) or hoses that are coupled to the couplers may use fittings 320 that are NPT fittings (e.g., female NPT fittings). Other types of hose or conduit fittings known in the art may also be used. In some embodiments, couplers 308, 210, and/or 312 may be formed as part of outer body 202.

In some embodiments, assembly 300 may include low-pressure side storage fitting 322 and/or high-pressure side storage fitting 324 (shown in FIGS. 7 and 8). In some embodiments, low-pressure side storage fitting 322 may be a double-ended fitting with one end coupled to outer body 302 and one end for coupling to conduit 314. Low-pressure side storage fitting 322 may be coupled to conduit 314 using coupling device 236 to store the conduit when the conduit is not in use. In some embodiments, high-pressure side storage fitting 324 may be a double-ended fitting with one end coupled to outer body 302 and one end for coupling to conduit 318. High-pressure side storage fitting 324 may be coupled to conduit 318 using coupling device 326 to store the conduit when the conduit is not in use. Coupling device 326 may be a coupling device (e.g., a quick coupling device such as a 14 mm×16 mm quick coupler device) for coupling to a high-pressure side inlet port of the refrigerant system.

In certain embodiments, conduits 314, 318 may include one or more valves 328. Valves 328 may be shutoff valves (e.g., ball valves). Valve 328 may be located along a length of conduit 314 or conduit 318. In certain embodiments, valve 328 may be located 12″ or less from coupling devices 236 and 326 along the length of conduit 314 or conduit 318. Valve 328 may be located within this distance to comply with EPA regulations.

In some embodiments, valve 330 may be located at an end of conduit 316. Valve 330 may be a can piercing type shutoff valve. Valve 330 may be used to pierce or puncture a top of a refrigerant can. In some embodiments, valve 330 may be a can piercing type shutoff valve for use only with 134a refrigerant cans. Valve 330 may be used to regulate flow from the refrigerant can (i.e., valve 330 may operate as a shutoff valve for the refrigerant can). In some embodiments, valve 330 may not operate as a shutoff valve, but rather as an attachment that pierces the refrigerant can without the ability to control the flow from the can.

In certain embodiments, conduits 314, 316, and/or 318 may be differentiated by, for example, color. For example, conduit 314 may be a blue conduit, conduit 316 may be a yellow conduit, and conduit 318 may be a red conduit. Using different colors for conduits 314, 316, 318 may allow for easier and safer operation of assembly 300 by a user (e.g., by a non-professional user).

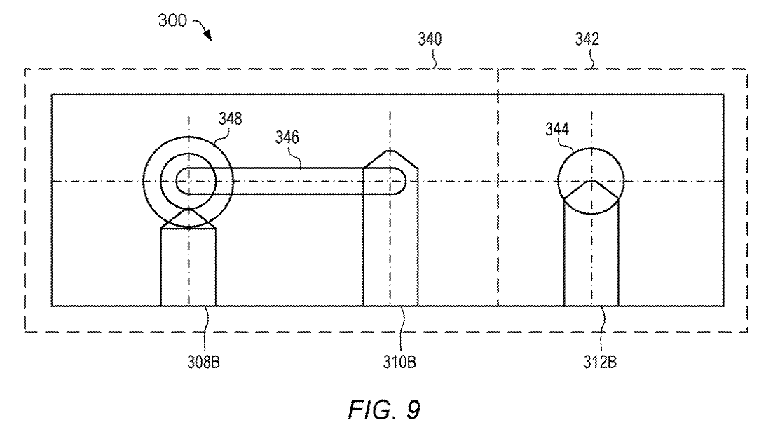

FIG. 9 depicts a schematic of the internal structure of an embodiment of assembly 300. Assembly 300 may be divided into two sections, low-pressure side 340 and high-pressure side 342. On high-pressure side 342, a gauge (e.g., high-pressure side gauge 306, depicted in FIGS. 7 and 8) may be coupled to opening 344. Opening 344 is in fluid communication with opening 312B. Thus, a gauge (e.g., high-pressure side gauge 306) may be used to measure pressure of the high-pressure side of a refrigerant system coupled to opening 312B.

On low-pressure side 340, opening 310B is in fluid communication with conduit 346. Conduit 346 may be in fluid communication with opening 308B and opening 348. Thus, refrigerant may be allowed to flow from the refrigerant can coupled to opening 310B to the low-pressure side of the refrigerant system coupled to opening 308B.

In an embodiment of assembly 300, fluid is not allowed to flow between opening 310B and opening 312B (i.e., between low-pressure side 340 and high-pressure side 342), which may be coupled to the high-pressure side of the refrigerant system. This configuration inhibits a user from accidentally attempting to charge the refrigerant system through the high-pressure side of the refrigerant system. Charging through the high-pressure side of a refrigerant system may be dangerous. Thus, assembly 300 may be easily and safely operated by both professional service personnel and non-professional consumers (e.g., motor vehicle owners).

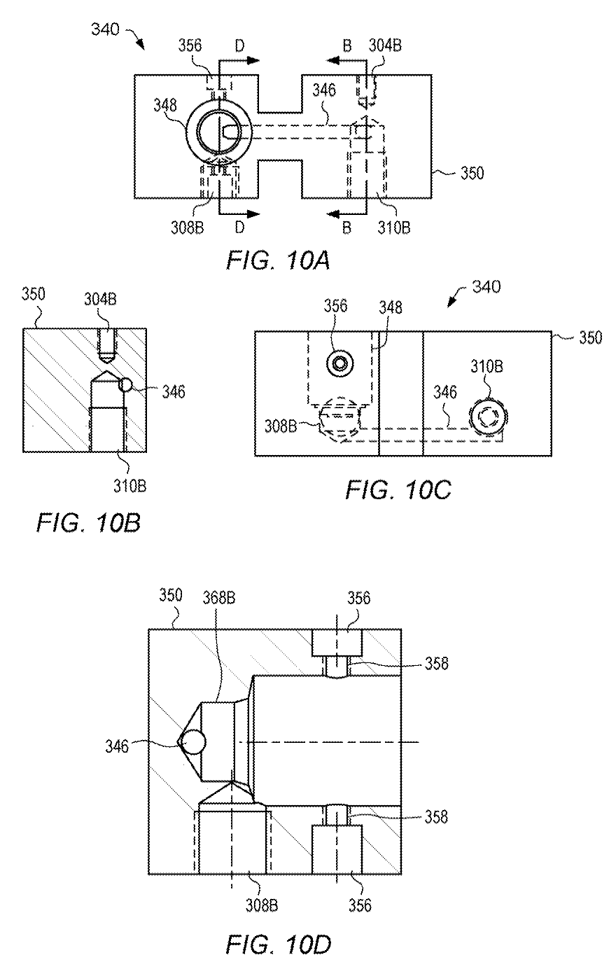

FIGS. 10-15 depict an embodiment of assembly 300. It is to be understood that variations in the design, construction, and/or assembly of assembly 300 and one or more of its components may be made without deviating from the operation or function of assembly 300 as described herein. For example, assembly 300 may be designed and assembled using fewer pieces or parts (e.g., low-pressure side 340 and high-pressure side 342 may be a single piece cast body).

In certain embodiments, low-pressure side pressure gauge apparatus 100 (depicted in FIGS. 1, 7, and 8) may be operated as a valve (e.g., a shutoff valve) for controlling a flow of refrigerant between opening 310B and opening 308B in addition to being used to measure a pressure of the low-pressure side of the refrigerant system. FIG. 10A depicts a front view of low-pressure side 340 of assembly 300. Low-pressure side 340 may include low-pressure body 350. FIG. 10B depicts a cross-sectional representation of low-pressure body 350 taken substantially along line B-B of FIG. 10A. FIG. 10C depicts a bottom view of low-pressure body 350. FIG. 10D depicts an expanded cross-sectional representation of low-pressure body 350 along substantially along line B-B of FIG. 10A.

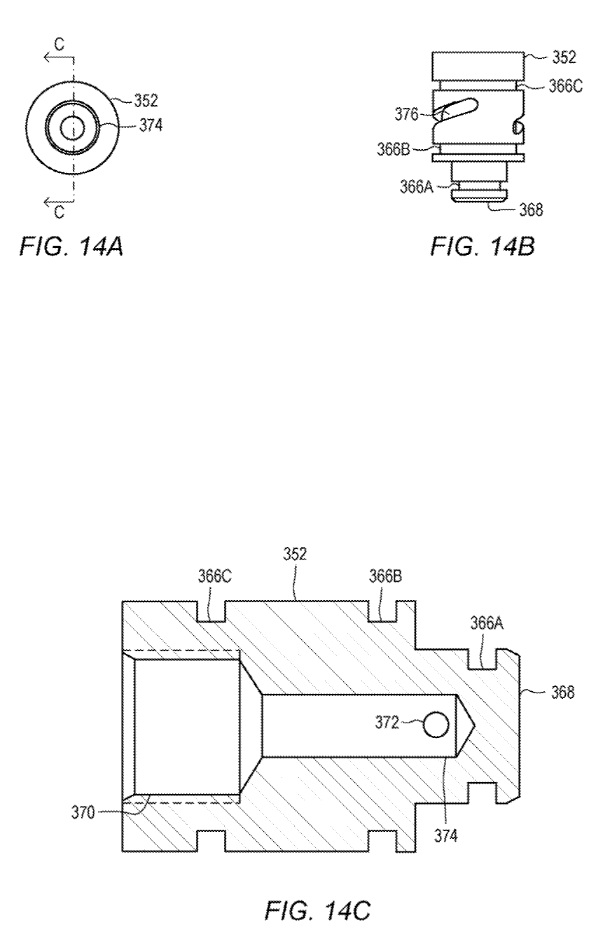

In certain embodiments, low-pressure body 350 may be a cast body (e.g., an aluminum die-cast body). Low-pressure body 350 may include opening 348. A gauge (e.g., gauge apparatus 100 depicted in FIGS. 1, 7, and 8) may be coupled to opening 348. In certain embodiments, the gauge may be coupled to opening 348 using a plunger (e.g., plunger 352 depicted in FIGS. 14A-14D). Opening 348 may be in fluid communication with conduit 346, opening 310B, and opening 308B, as shown in FIGS. 9, 10A, and 10B. Openings 308B and/or 310B may be threaded (e.g., a ⅛″NPT female thread) to allow for coupling to the openings.

In certain embodiments, low-pressure body 350 may include hanger opening 304B. Hanger opening 304B may be used to couple to hanger 304, depicted in FIGS. 7 and 8. For example, hanger 304 may be threaded into hanger opening 304B.

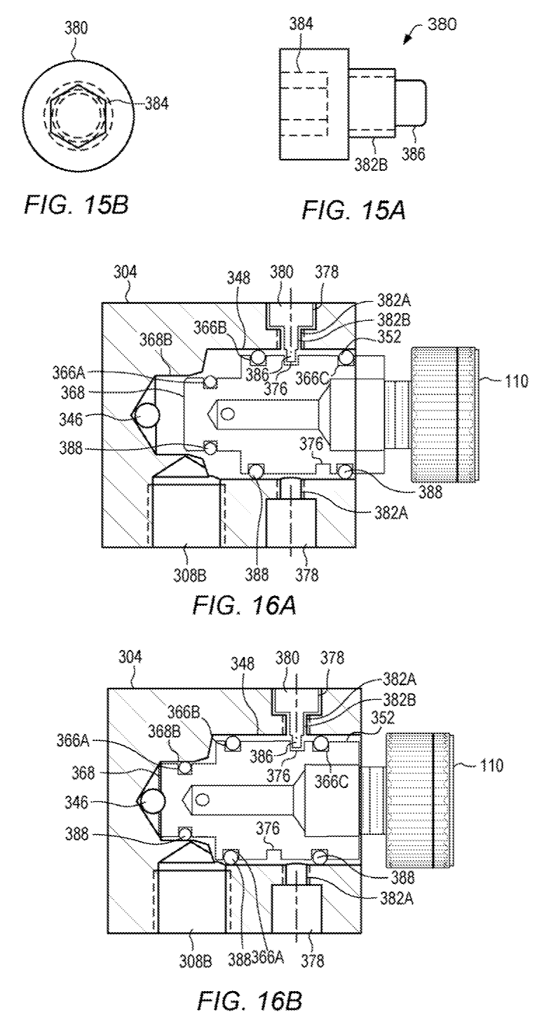

In certain embodiments, low-pressure body 350 may include holes 356. Holes may include threaded portions 358. Holes 356 and threaded portions 358 may be used to allow a pin (e.g., pin 360 depicted in FIGS. 15A and 15B) to be coupled to (e.g., located in) low-pressure body 350.

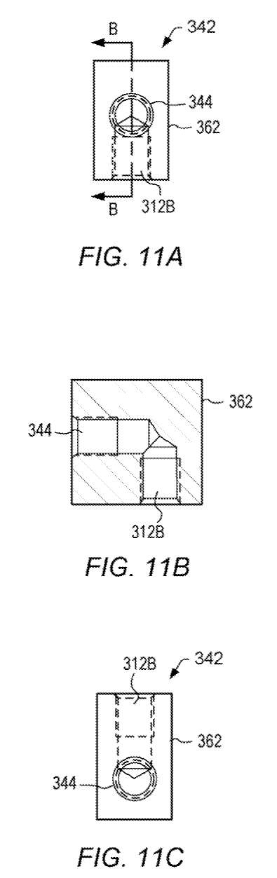

FIG. 11A depicts a front view of high-pressure side 342 of assembly 300. As shown in FIG. 11A, high-pressure side 342 may include high-pressure body 362. FIG. 11B depicts a cross-sectional representation of high-pressure body 362 taken substantially along line B-B of FIG. 11A. FIG. 11C depicts a bottom view high-pressure body 362.

In certain embodiments, high-pressure body 362 may be a cast body (e.g., an aluminum die-cast body). High-pressure body 362 may include opening 344. A gauge (e.g., gauge 306 depicted in FIGS. 7 and 8) may be coupled to opening 344. Opening 344 may be threaded (e.g., a ⅛″ NPT female thread) to allow a gauge to be coupled to the opening. Opening 344 may be in fluid communication with opening 312B, as shown in FIGS. 9, 11A, and 11B. Opening 312B may be threaded (e.g., a ⅛″ NPT female thread).

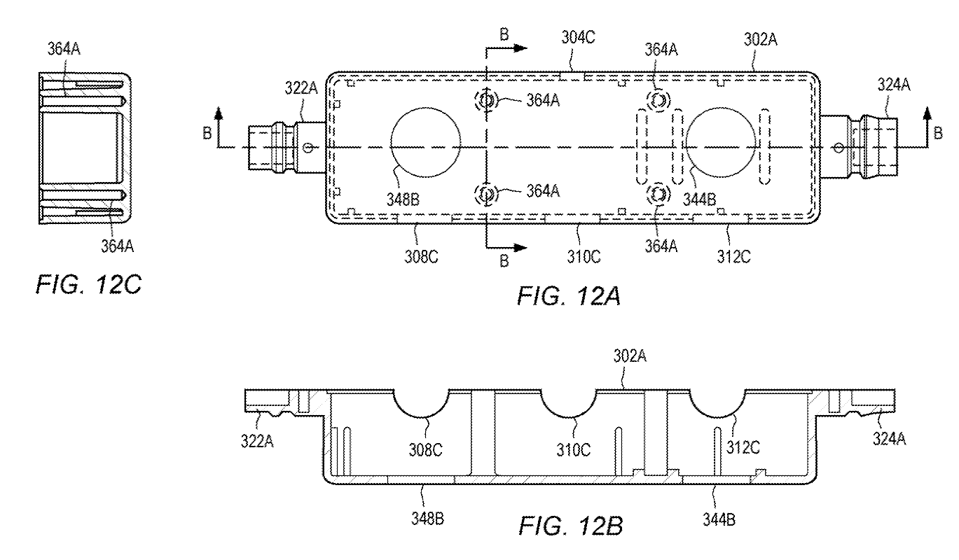

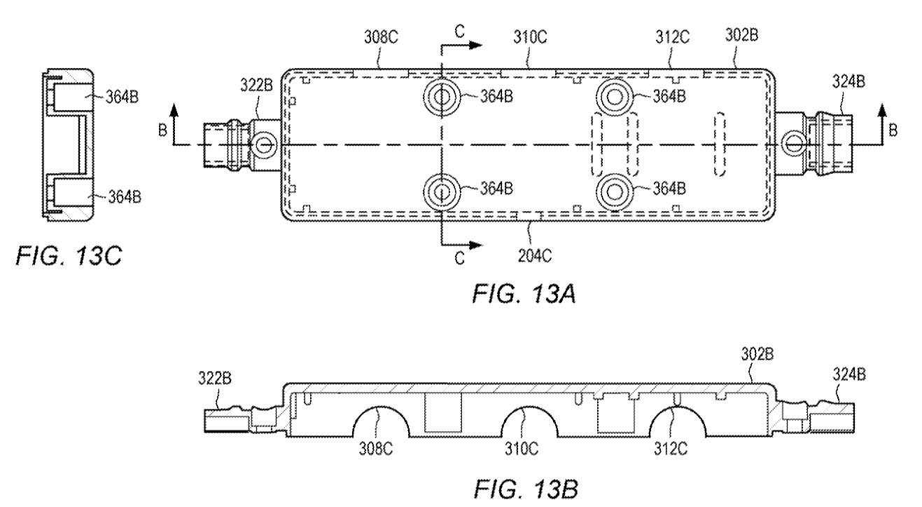

In an embodiment, assembly 300 may include an outer body (e.g., outer body 302 shown in FIGS. 7 and 8) that encloses low-pressure body 350 and high-pressure body 362. An outer body may be formed as a single piece including means for placing low-pressure body 350 and high-pressure body 362 inside the outer body. In certain embodiments, an outer body may include two or more pieces that are coupled together to form the outer body. FIGS. 12A-13C depict an embodiment of an outer body that includes two pieces coupled together to form the outer body. FIGS. 12A-12C depict representations of an embodiment of outer body front portion 302A. FIG. 12A depicts a front view of an embodiment of outer body front portion 302A. FIG. 12B depicts a cross-sectional representation of outer body front portion 302A taken substantially along line B-B of FIG. 12A. FIG. 12C depicts a cross-sectional representation of outer body front portion 302A taken substantially along line C-C of FIG. 12A.

As shown in FIGS. 12A-12C, outer body front portion 302A may include opening 348B that corresponds to opening 348 of low-pressure body 350, depicted in FIGS. 100A-10D. Outer body front portion 302A may include opening 344B that corresponds to opening 344 of high-pressure body 362, depicted in FIGS. 11A-11C. Outer body front portion 302A may include front portions of openings 304C, 308C, 310C, 312C that correspond to openings 304B, 308B, 310B, 312B, depicted in FIGS. 9-11C. In certain embodiments, outer body front portion 302A may include front portions 322A, 324A of low-pressure side storage fitting 322 and/or high-pressure side storage fitting 324 (shown in FIGS. 7 and 8).

Outer body front portion 302A may be a molded body (e.g., an injection molded plastic body) or a cast body (e.g., an aluminum die cast body). As shown in FIGS. 12A-12C, outer body front portion 302A may include front portion couplers 364A. Front portion couplers 364A may be used for coupling outer body front portion 302A to outer body rear portion 302B, shown in FIGS. 13A-13C. In some embodiments, front portion couplers 364A may include female threading for coupling to a screw or bolt.

FIGS. 13A-13C depict representations of an embodiment of outer body rear portion 302B. FIG. 13A depicts a front view of an embodiment of outer body rear portion 302B. FIG. 13B depicts a cross-sectional representation of outer body rear portion 302B taken substantially along line B-B of FIG. 13A. FIG. 13C depicts a cross-sectional representation of outer body rear portion 302B taken substantially along line C—C of FIG. 13A.

Outer body rear portion 302B may be a molded body (e.g., an injection molded plastic body) or a cast body (e.g., an aluminum die cast body). Outer body rear portion 302B may include rear portions of openings 304C, 308C, 310C, 312C that correspond to openings 304B, 308B, 310B, 312B, depicted in FIGS. 9-11C. In certain embodiments, outer body rear portion 302B may include rear portions 322B, 324B of low-pressure side storage fitting 322 and/or high-pressure side storage fitting 324 (shown in FIGS. 7 and 8).

As shown in FIGS. 13A-13C, outer body rear portion 302B may include rear portion couplers 364B. Rear portion couplers 364B may be used for coupling outer body rear portion 302B to outer body front portion 302A, shown in FIGS. 12A-12C. In some embodiments, rear portion couplers 364B may be recesses that function as washers for screws or bolts to couple outer body rear portion 302B to outer body front portion 302A.

FIGS. 14A-14C depict an embodiment of plunger 352 that may be used in opening 348, depicted in FIGS. 9-10D. FIG. 14A depicts a top view of an embodiment of plunger 352. FIG. 14B depicts a side view of an embodiment of plunger 352. FIG. 14C depicts a cross-sectional representation of plunger 352 taken substantially along line C-C of FIG. 14A.

Plunger 352 may be placed in opening 348 (depicted in FIGS. 10A-10D) to allow a gauge (e.g., gauge apparatus 100 depicted in FIGS. 1, 7, and 8) to be coupled to the opening. Plunger 352 may have a shape substantially similar to an interior shape of opening 348, as shown in FIGS. 10A-10D and 14A-14D. Plunger 352 may have outer dimensions substantially similar to the dimensions of walls of opening 348 so that the plunger may fit snugly in the opening. Plunger 352 may include sealing grooves 366A-C. Sealing grooves 366A-C may be, for example, o-ring grooves. O-rings or another sealing material may be placed in sealing grooves 366A-C so that a seal is made between plunger 352 and the walls of opening 348. Plunger 352 may have end 368 at a forward portion of the plunger. End 368 may have a shape that appropriately matches a shape of diameter 368B of opening 348, shown in FIG. 10D.

Plunger 352 may include coupling portion 370. Coupling portion 370 may be used to couple plunger 352 to a gauge (e.g., gauge 206 depicted in FIGS. 7 and 8). In certain embodiments, coupling portion 370 may be a threaded portion so that a gauge may be coupled by threading the gauge into the coupling portion. For example, coupling portion 370 may be a female threaded ⅛″ NPT fitting.

In certain embodiments, plunger 352 may include opening 372. Opening 372 may allow fluids to enter interior 374 of plunger 352. Thus, a gauge (e.g., gauge apparatus 100 depicted in FIGS. 1, 7, and 8) coupled to plunger 352 may be used to measure a pressure of fluid (e.g., refrigerant gas or refrigerant liquid) in interior 374 of the plunger and openings in fluid communication with interior 374 through opening 372. For example, the gauge may measure pressure of fluid in opening 308B when interior 374 is in fluid communication with opening 308B. Thus, the gauge may be used to indicate pressure of fluid in opening 308B and components coupled to opening 308B (e.g., the low-pressure side of the refrigerant system).

Plunger 352 may include groove 376. Groove 376 may be used as a guide for operation of plunger 352 within opening 348. In certain embodiments, groove 376 may have a design (e.g., a shape and length) that controls the movement of plunger 352. For example, groove 376 may include first and second ends so that movement of plunger 352 is limited by the first and second ends. Pins or other extending devices (e.g., pin 380 shown in FIGS. 15A and 15B) may be placed in holes 378, shown in FIG. 10D, for simultaneous use as guides for groove 376. In some embodiments, only one pin or one extending device may be placed in one of holes 378 as a guide for groove 376.

FIGS. 15A and 15B depict top and front views of an embodiment of pin 380. Pin 380 may be placed in hole 378, shown in FIG. 10D, to guide movement of plunger 352, shown in FIGS. 14A-14C. Pin 380 may include threaded portion 382B. Threaded portion 382B may mate with threaded portion 382A of hole 378, shown in FIG. 10D. Pin 380 may include opening 384. Opening 384 may include, for example, a hex wrench design, a star wrench design, or other similarly designed female fitting used to rotate pin 380 into hole 378 along threaded portions 382A, 382B. Extension 386 may extend into opening 348 such that the extension enters groove 376 of plunger 352, as shown in FIGS. 16A and 16B.

FIGS. 16A and 16B depict representational embodiments of plunger 352 in opening 348 in an open fluid flow position (FIG. 16A) and a closed fluid flow position (FIG. 16B). Pin 380 may be used as a guide for groove 376 so that as plunger 352 is rotated, the plunger moves back and forth along a length of opening 348 according to a shape of the groove. Thus, plunger 352 may be used to open and close fluid flow between conduit 346 and opening 308B (i.e., plunger 352 may operate as a valve to open and close fluid flow between conduit 346 and opening 308B). In certain embodiments, rotation of gauge body 204 of apparatus 100 may rotate plunger 352 and cause movement of the plunger back and forth along a length of opening 348. Thus, gauge apparatus 100 may be used as a handle for operating plunger 352 and opening or closing the flow of fluid between conduit and opening 308B.

As shown in FIG. 16B, fluid flow may be closed off when end 368 of plunger 352 is moved inside diameter 368B such that o-ring 388 located in sealing groove 366A inhibits fluid flow between conduit 346 and opening 210B. As shown in FIG. 16A, fluid flow may be allowed between conduit 346 and opening 210B when end 368 of plunger 352 is moved out of or almost out of diameter 368B sufficiently far enough such that o-ring 388 in sealing groove 366A does not inhibit flow between conduit 346 and opening 308B. O-rings 388 located in sealing grooves 366B, 366C may form a seal against walls of opening 348 to inhibit fluid from exiting the opening.

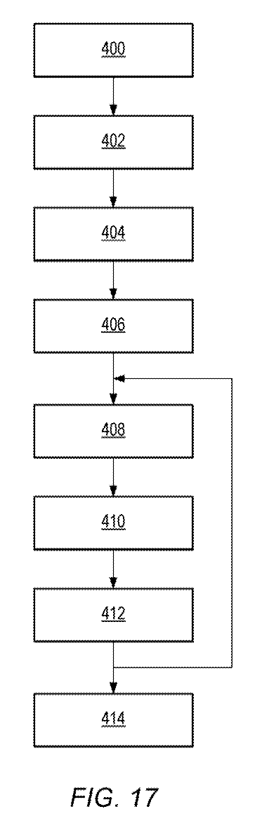

In certain embodiments, assembly 300 may be used both for measuring low-pressure side and high-pressure side pressures of the refrigerant system (e.g., a motor vehicle refrigerant system) and for controllably charging the refrigerant system using a refrigerant can or other refrigerant source. FIG. 17 depicts a flowchart of an embodiment of a method for pressure testing and/or recharging the refrigerant system using assembly 300. The steps in the method depicted in FIG. 17 may reference elements identified in the embodiments depicted in FIGS. 7-16. The pressure of the low-pressure side or the high-pressure side of the refrigerant system may be measured with or without the refrigerant can coupled to assembly 300.

In step 400, the user may turn on the refrigerant system and set the refrigerant system to maximum cooling. Care should be taken by the user to ensure the compressor clutch of the refrigerant system is engaged. If the compressor clutch is not engaged, a user may add up to about one can of refrigerant until the compressor clutch becomes engaged. If the compressor clutch does not become engaged after adding refrigerant, the user may seek repair for the refrigerant system.

After turning on the refrigerant system, the user may couple assembly 300 to the refrigerant system by coupling device 236 to an inlet port on the low-pressure side of the refrigerant system and coupling device 326 to an inlet port on the high-pressure side of the refrigerant system (step 402). In certain embodiments, assembly 300 may be coupled to the refrigerant system with shutoff valves 328 closed (e.g., to inhibit accidental loss of refrigerant). Coupling devices 236, 326 may be of different sizes to match the inlet port fittings for the low-pressure side and the high-pressure side of the refrigerant system, respectively. These differing sizes may inhibit the user from accidentally coupling gauges 100, 306 to the wrong inlet ports.

After coupling assembly 300 to the inlet ports of the refrigerant system, the user may measure pressure in the low-pressure side of the refrigerant system and/or the high-pressure side of the refrigerant system (step 404). Shutoff valves 328 may be opened if previously closed. The user may rotate faceplate 110 to point temperature indicator 112 to ambient temperature. Positioning temperature indicator 112 positions low pressure range indicator 114 and upper pressure range indicator 116 at pressure indicia on pressure scale 104 to indicate a desired pressure range for sufficient refrigerant in the refrigeration system.

If additional refrigerant is needed, they user may couple a refrigerant can (e.g., an R-134a refrigerant can for an R-134a refrigerant system) to assembly 300 with valve 330 (step 406). Valve 330 may pierce the refrigerant can and, in some embodiments, may be used as a shutoff valve for the refrigerant can.

The user may rotate gauge apparatus 100 a selected rotation in a first direction (e.g., a ¼ turn counterclockwise) to allow refrigerant to flow from the refrigerant can to the low-pressure side of the refrigerant system (step 408). In certain embodiments, refrigerant may be added in small increments. This may inhibit overcharging of the refrigerant system. The user may rotate gauge 100 the selected rotation in an opposite direction to the first direction (e.g., a ¼ turn clockwise) to stop the flow of refrigerant to the low-pressure side of the refrigerant system (step 410). In some embodiments, the user may use valve 330 to reduce or stop the flow of refrigerant.

The user may measure the low-pressure side pressure using gauge 100 after stopping the flow of refrigerant (step 412). If the pressure of refrigerant remains too low as determined by rotating faceplate 110 as described herein, steps 408-412 may be repeated until a sufficient pressure (i.e., a sufficient charge of refrigerant) is achieved. After sufficiently filling the refrigerant system with refrigerant, assembly 300 may be uncoupled from the refrigerant system (step 414). Shutoff valves 328 and/or valve 330 may be closed before uncoupling assembly 300 from the refrigerant system to inhibit accidental leakage of refrigerant from the assembly and/or from the refrigerant system.

The empty refrigerant can may be uncoupled from assembly 300 and disposed of properly. Assembly 300 may be stored with shutoff valves 328 closed and valve 330 closed. This may inhibit accidental leakage of refrigerant from assembly 300. If the refrigerant can is not empty, the refrigerant may remain coupled to assembly 300 for later use. Care should be taken in storing assembly 300 and the refrigerant can so that the refrigerant can is not accidentally opened or punctured.

In this patent, certain U.S. patents and U.S. patent applications have been incorporated by reference. The text of such U.S. patents and U.S. patent applications is, however, only incorporated by reference to the extent that no conflict exists between such text and the other statements and drawings set forth herein. In the event of such conflict, then any such conflicting text in such incorporated by reference U.S. patents and U.S. patent applications is specifically not incorporated by reference in this patent.

Further modifications and alternative embodiments of various aspects of the invention will be apparent to those skilled in the art in view of this description. Accordingly, this description is to be construed as illustrative only and is for the purpose of teaching those skilled in the art the general manner of carrying out the invention. It is to be understood that the forms of the invention shown and described herein are to be taken as the presently preferred embodiments. Elements and materials may be substituted for those illustrated and described herein, parts and processes may be reversed, and certain features of the invention may be utilized independently, all as would be apparent to one skilled in the art after having the benefit of this description of the invention. Changes may be made in the elements described herein without departing from the spirit and scope of the invention as described in the following claims.

1. A pressure gauge apparatus for determining refrigerant pressures in a refrigeration system, comprising:
a pressure gauge;
a faceplate coupled to the pressure gauge, wherein the faceplate is configured to rotate such that a selected temperature and a defined pressure range are visually indicated on the pressure gauge; and
wherein the defined pressure range correlates to an adequate amount of refrigerant in the refrigeration system at the selected temperature.

2. The apparatus of claim 1, wherein the faceplate comprises:
a temperature indicator;
a low pressure indicator; and
an upper pressure indicator; and wherein the temperature indicator, the low pressure indicator and the upper pressure indicator are coupled together.

3. The apparatus of claim 1, wherein the pressure gauge comprises pressure indicia and a rotatable pressure indicator, the pressure indicia being angularly oriented with respect to the axis about which the pressure indicator rotates.

4. (canceled)

5. The pressure gauge of claim 1, wherein the pressure gauge comprises temperature indicia and a rotatable pressure indicator, the temperature indicia being angularly oriented with respect to the axis about which the pressure indicator rotates and wherein the temperature indicia are aligned with pressure indicia on the pressure scale.

6. The apparatus of claim 5, wherein the temperature indicia range from about 65° F. to about 110° F. and wherein the temperature indicia are aligned with pressure indicia ranging from about 30 psi to about 50 psi.

7. (canceled)

8. (canceled)

9. The apparatus of claim 1, wherein the faceplate is removably coupled to the pressure gauge.

10. The apparatus of claim 1, further comprising a grip coupled to at least a portion of the pressure gauge and coupled to the faceplate, wherein the grip is configured to rotate the faceplate.

11-14. (canceled)

15. A method of determining refrigerant in a refrigeration system, comprising
connecting a pressure gauge to the refrigeration system, the pressure gauge comprising a faceplate;
rotating the faceplate to visually indicate on the pressure gauge a selected temperature and a defined pressure range, wherein the defined pressure range correlates to an adequate amount of refrigerant in the refrigeration system at the selected temperature; and
determining an adequacy of refrigerant in the refrigeration system at the selected temperature by reading a pressure on the pressure gauge.

16. The method of claim 15, wherein the faceplate comprises:
a temperature indicator;
a low pressure indictor; and
a upper pressure indicator, wherein the indicators are coupled together.

17. The method of claim 16, wherein rotating the faceplate positions the low pressure indicator at a low pressure limit and positions an upper pressure indicator at an upper pressure limit, and wherein the lower pressure and upper pressure limits defines an adequate pressure range for refrigerant in the refrigeration system.

18. The method of claim 15, wherein the determining an adequacy of refrigerant comprises determining if the pressure reading is in the defined pressure range.

19. The method of claim 15, wherein the determining an adequacy of refrigerant comprises determining if the pressure reading is below the defined pressure range.

20. The method of claim 15, wherein the determining an adequacy of refrigerant comprises determining if the pressure reading is above the defined pressure range.

21-26. (canceled)

27. The method of claim 15, further comprising a grip coupled to the faceplate and wherein indicating the desired temperature comprises rotating grip until the temperature indicator points at the desired temperature.

28. The method of claim 15, wherein the refrigerant circuit is a vehicle refrigerant circuit.

29. A method of charging and pressure testing a refrigerant circuit having an inlet fitting, comprising:
connecting a coupling structure of a refrigerant charging/pressure testing assembly to the inlet fitting, wherein the refrigerant charging/pressure testing assembly comprises:
a conduit having a first end and a second end;
the coupling structure coupled to the first end; and
a pressure gauge connected in the conduit between the coupling structure and the second end of the conduit, wherein the pressure gauge comprises a faceplate; and
rotating the faceplate to visually indicate on the pressure gauge a selected temperature and a defined pressure range; and
determining the adequacy of the refrigerant charge in the refrigerant circuit by reading the pressure gauge.

30. The method of claim 29, wherein the faceplate comprises:
a temperature indicator;
a low pressure indictor; and
a upper pressure indicator; and wherein the indicators are coupled together.

31. The method of claim 30, wherein rotating the faceplate to visually indicate a selected temperature and a defined pressure range on the pressure gauge positions the low pressure indicator at a low pressure limit and positions an upper pressure indicator at an upper pressure limit, and wherein the lower pressure and upper pressure limits define the pressure range.

32-42. (canceled)

43. The method of claim 29, further comprising coupling the second end of the conduit to an outlet of a pressurized refrigerant container and allowing refrigerant to flow from the pressurized refrigerant container into the refrigerant circuit through the conduit until the pressure indicator of the pressure gauge moves into the in-range pressure range.

44. The method of claim 29, wherein the refrigerant charging/pressure testing assembly further comprises a check valve connected in the conduit between the pressure gauge and the second end of the conduit, wherein the check valve is operative to inhibit fluid flow through the conduit toward the second end of the conduit.

45-48. (canceled)
